(19) United States
(12) Patent Application Publication
(10) Pub. No.: US 2015/0160394 A1
(43) Pub. Date: Jun. 11, 2015

(54) PLANAR LIGHT SOURCE DEVICE AND LIQUID CRYSTAL DISPLAY DEVICE

(71) Applicant: MITSUBISHI ELECTRIC CORPORATION, Tokyo (JP)

(72) Inventors: Nami Nakano, Tokyo (JP); Rena Nishitani, Tokyo (JP); Tomohiro Sasagawa, Tokyo (JP); Nobutaka Kobayashi, Tokyo (JP)

(73) Assignee: MITSUBISHI ELECTRIC CORPORATION, Tokyo (JP)

(21) Appl. No.: 14/414,060

(22) PCT Filed: Jul. 17, 2013
(86) PCT No.: PCT/JP2013/004349

§ 371 Date: Jan. 9, 2015

(30) Foreign Application Priority Data
Jul. 31, 2012 (JP) 2012-169277

(51) Int. Cl. F21V 8/00; G02F 1/1335

(52) U.S. Cl. CPC G02B 6/001; G02B 6/0068; G02B 6/0055; G02F 1/1336

(57) ABSTRACT

The planar light source device 200 includes a laser light source 7, a light guide rod 4, and a reflection unit 6. The laser light source 7 emits laser light 71. The light guide rod 4 having a rod shape has a light incident surface 41 at the end portion of rod shape in its longitudinal direction, and converts the laser light 71 entering through the light incident surface 41 into liner-shaped light. The reflection unit 6 has a box-like shape including a base plate 61, side plates 62, 63, 64, 65 being connected to the base plate 61, and an opening 66 facing the base plate 61, and the inner surfaces of base plate 61 and side plates 62, 63, 64, 65 configure reflection surfaces. The light guide rod 4 is disposed at a portion enclosed by the reflection surface of base plate 61 and the reflection surfaces of side plates 62, 63, 64, 65. The liner-shaped light projected from the light guide rod 4 is reflected by the reflection surface of base plate 61 and the reflection surfaces of side plates 62, 63, 64, 65, and is projected through the opening 66.

### TECHNICAL FIELD

The present invention relates to a planar light source device having a sheet-like light emitting surface. The present invention also relates to a liquid crystal display device having a planar light source device and a liquid crystal display element.

### BACKGROUND ART

A liquid crystal display element equipped in a liquid crystal display device is not self-luminous. Therefore, a liquid crystal display device has a backlight device at the rear side of a liquid crystal display element, serving as a light source for illuminating the liquid crystal display element. Light emitted from the backlight device enters the liquid crystal display element and image light is projected therefrom. “Image light” means light having image information. In recent years, since the performance of blue light emitting diode (hereinafter, referred to as LED) has been tremendously improved, a backlight device utilizing the blue LED as its light source has been widely employed.

A light source utilizing the blue LED has the blue LED and a fluorescent material that absorbs light emitted from the blue LED and that emits light having a complementary color for the blue light. Such a LED is called as a white LED. The complementary color for the blue light is yellow light including green and red light.

A white LED has high photoelectric conversion efficiency and thus is useful for reducing power consumption. “Photoelectric conversion” means converting electrical energy into light energy. On the other hand, however, there has been a problem that a color reproduction range of the white LED is narrow since its wavelength bandwidth is wide. In a liquid crystal display device, color filters are provided in its liquid crystal display element. In the liquid crystal display device, spectral ranges only for red, green, and blue are extracted by using the color filters so as to perform color representation. For a light source having a continuous spectrum with a wide wavelength bandwidth such as the white LED, displayed color of the color filter is needed to have high color purity in order to broaden its color reproduction range. That is, the wavelength bandwidth of light transmitting the color filter is set to be narrow. However, if the wavelength bandwidth of light transmitting the color filter is set to be narrow, efficiency for light utilization decreases. The reason is that an amount of unnecessary light useless for displaying an image in the liquid crystal display element increases.

In order to broaden the color reproduction range while minimizing light loss caused by the color filter, it is necessary to employ a light source which emits light having a narrow wavelength bandwidth. In other words, it is necessary to employ a light source which emits light having high color purity.

Thus, in order to obtain an image having a wide color reproduction range and high brightness, a liquid crystal display device has been proposed recently that has a backlight unit using an LED or laser, as a light source, which has a narrow wavelength and is monochromatic. “Narrow wavelength” means high color purity. Especially, the laser has an excellent monochromaticity. Also, the laser has high luminous efficiency. Therefore, it is possible for a liquid crystal display device employing a laser to provide an image having a wide color reproduction range and high brightness. In addition, a liquid crystal display device with low power consumption can be provided. That is, since the laser especially has the excellent monochromaticity, it is possible to widely broaden the color reproduction range and to greatly improve image quality of the liquid crystal display device.

It is necessary for a backlight device to be a planar light source which illuminates the liquid crystal display element with light having an in-plane distribution of uniform intensity. “In-plane” means within a range of display screen of the liquid crystal display device. “Planar light source” means a light source emitting sheet-like light. The laser is a point light source having very high directivity. “Point light source” means a light source in which light is emitted from one point. “One point” means an area of light source that can be treated as a point without any problem in an optical calculation considering the performance of products. Thus, it is necessary for a backlight device employing a laser as a light source to have an optical system for converting laser light being a point light source into a planar light source. The planar light source is a light source for illuminating a liquid crystal display element 1 with light having a uniform intensity distribution.

In Patent Document 1, for example, a technology for obtaining a planar light source is disclosed in which a laser is employed as a light source, and a light guide plate and an illuminating optical system configured with a plurality of lenses are provided.

### PRIOR ART DOCUMENT

### Patent Document

Patent Document 1; Japanese Unexamined Patent Application Publication No. 2008-66162

### SUMMARY OF THE INVENTION

### Problem that the Invention is to Solve

An optical system of the above-described backlight device in Patent Document 1 has a large size, since an illuminating optical system configured with a plurality of lenses is provided. That is, it is difficult to downsize the backlight device in Patent Document 1. In recent years, a design is preferred in which the width of a frame, or a cabinet portion, enclosing a display screen is narrowed. Such a frame, or a cabinet portion, is called as “bezel”. Since the large optical system described in Patent Document 1 is disposed at a bezel portion, it is difficult to narrow the bezel portion. Note that a bezel having a narrow width is called as “narrowed bezel”.

The present invention is made considering the above, and is to realize miniaturization of a planar light source device and a liquid crystal display device by downsizing an optical system disposed at the periphery of a display screen, even in a case where a laser light source is employed.

### Means for Solving the Problem

The present invention is made considering the above, and a planar light source device is configured with a first light source that emits first light; a light guide rod that has a rod shape, that has a light incident surface at an end portion of the rod shape, and that converts the first light entering through the light incident surface into liner-shaped light; and a reflection unit that has a box-like shape including a base plate, side plates being connected to the base plate, and an opening facing the base plate, inner surfaces of the base plate and the side plates being reflection surfaces, wherein the light guide rod is disposed at a portion enclosed by the reflection surfaces; and the liner-shaped light projected from the light guide rod is reflected by the reflection surfaces and is projected through the opening.

### Advantageous Effects of the Invention

In the present invention, miniaturization of a planar light source device and a liquid crystal display device is realized by downsizing an optical system disposed at the periphery of a display screen, even in a case where a laser light source is employed.

### BRIEF DESCRIPTION OF DRAWINGS

FIG. 1 is a configuration diagram schematically showing a configuration of a liquid crystal display device (planar light source device included) in Embodiment 1 according to the present invention.

FIG. 2 is a perspective view schematically showing a configuration of the planar light source device in Embodiment 1 according to the present invention.

FIG. 3 is a schematic diagram schematically showing a configuration of a light guide rod in Embodiment 1 according to the present invention.

FIG. 4 is a schematic diagram schematically showing another configuration of the light guide rod in Embodiment 1 according to the present invention.

FIG. 5 is a schematic diagram schematically showing a layout of the light guide rod and a laser light source in Embodiment 1 according to the present invention.

FIG. 6 is a configuration diagram schematically showing a configuration example of the liquid crystal display device (planar light source device included) in Embodiment 1 according to the present invention.

FIG. 7 is a configuration diagram schematically showing a configuration of the liquid crystal display device (planar light source device included) in Embodiment 1 according to the present invention.

FIG. 8 is a configuration diagram schematically showing another configuration of the liquid crystal display device (planar light source device included) in Embodiment 1 according to the present invention.

FIG. 9 is a configuration diagram schematically showing a configuration of a liquid crystal display device (planar light source device included) in Embodiment 2 according to the present invention.

FIG. 10 is a perspective view schematically showing a configuration of the planar light source device in Embodiment 2 according to the present invention.

FIG. 11 is a block diagram showing a driving method for a liquid crystal display element and light sources in embodiments according to the present invention.

FIG. 12 is a configuration diagram schematically showing a configuration example of the liquid crystal display device (planar light source device included) in Embodiment 2 according to the present invention.

FIG. 13 is a configuration diagram schematically showing another configuration example of the liquid crystal display device (planar light source device included) in Embodiment 2 according to the present invention.

FIG. 14 is a configuration diagram schematically showing another configuration example of the liquid crystal display device (planar light source device included) in Embodiment 2 according to the present invention.

FIG. 15 is a diagram schematically showing a configuration for enhancing diffusibility of light projected from a light guide rod in Embodiment 3 according to the present invention.

FIG. 16 is a diagram schematically showing another configuration for enhancing diffusibility of the light projected from the light guide rod in Embodiment 3 according to the present invention.

FIG. 17 is a diagram showing a case where prism sheets are applied to the light guide rods attached to a reflection unit in Embodiment 3 according to the present invention.

FIG. 18 is a diagram showing a case where diffusion sheets are applied to the light guide rods attached to the reflection unit in Embodiment 3 according to the present invention.

FIG. 19 is a diagram schematically showing another configuration for enhancing diffusibility of the light projected from the light guide rod in Embodiment 3 according to the present invention.

### MODE FOR CARRYING OUT THE INVENTION

### Embodiment 1

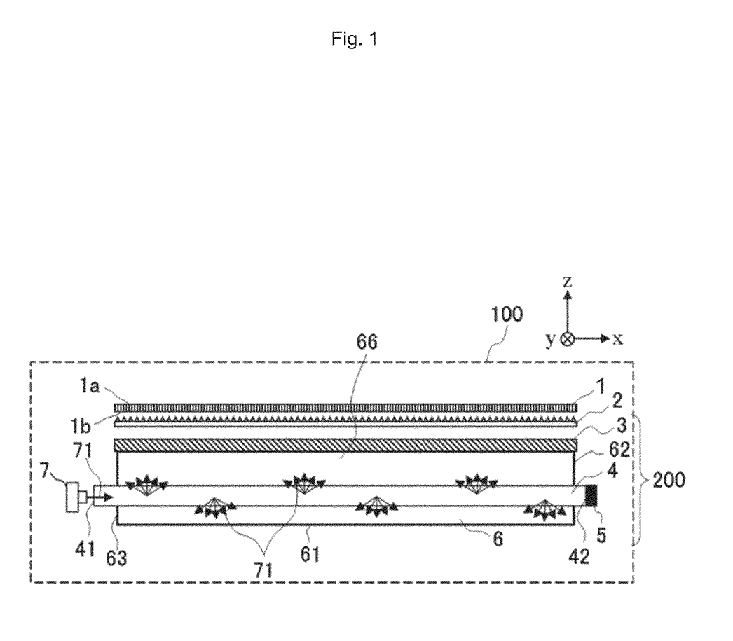

FIG. 1 is a configuration diagram schematically showing a configuration of a liquid crystal display device 100 (planar light source device 200 included) in Embodiment 1 according to the present invention. In order to facilitate the explanation, coordinate axes of x-y-z rectangular coordinate system are shown in each diagram. In the following explanation, the short side direction of a display screen 1a of a liquid crystal display element (liquid crystal panel) 1 is defined to be the x-axis direction. The x-axis direction coincides with the right and left direction in FIG. 1. The x-axis direction coincides with the up and down direction of liquid crystal display device 100. The long side direction of the display screen 1a of the liquid crystal display element 1 is defined to be the y-axis direction. The y-axis direction is a direction perpendicular to a sheet where FIG. 1 is illustrated. The y-axis direction coincides with the right and left direction of liquid crystal display device 100. The direction perpendicular to the x-y plane is defined to be the z-axis direction. The x-y plane is a plane which includes the x-axis and y-axis. The z direction coincides with the up and down direction in FIG. 1. The z direction coincides with the front and rear direction of liquid crystal display device 100 toward the display screen 1a. A direction from downside to upside of the liquid crystal display device 100 is the positive direction of x-axis (+x-axis direction). The opposite direction thereto is the negative direction of x-axis (−x-axis direction). A direction from right side to left side of the liquid crystal display device 100 toward the display screen 1a is the positive direction of y-axis (+y-axis direction). The opposite direction thereto is the negative direction of y-axis (−y-axis direction). A direction from rear surface 1b side to display screen 1a side of the liquid crystal display device 100 is the positive direction of z-axis (+z-axis direction). The opposite direction thereto is the negative direction of z-axis (−z-axis direction).

As shown in FIG. 1, the liquid crystal display device 100 according to Embodiment 1 includes the liquid crystal display element 1 of transmission type and the planar light source device 200. The liquid crystal display device 100 may include an optical sheet 2. The planar light source device 200 projects light toward the rear surface 1b of liquid crystal display element 1 through a diffusion plate 3. If the liquid crystal display device 100 includes the optical sheet 2, the light emitted from the planar light source device 200 is projected toward the rear surface 1b of liquid crystal display element 1 through the optical sheet 2. These constituent elements 1, 2, and 200 are sequentially arranged from +z-axis direction toward −z-axis direction. “Arrange” means to line up. Here, it means that plate-like members are lined up in a laminated manner.

The display screen 1a of liquid crystal display element 1 is a plane parallel to the x-y plane. A liquid crystal layer of liquid crystal display element 1 has a sheet-like structure parallel to the x-y plane. The display screen 1a of liquid crystal display element 1 usually has a rectangular shape. That is, neighboring two sides of display screen 1a cross at right angles. “Neighboring two sides of display screen 1a” mean the long side in y-axis direction and the short side in x-axis direction. Note that the display screen 1a may have another shape.

As shown in FIG. 1, the planar light source device 200 includes a light guide rod 4, a reflection unit 6, and a laser light source 7. The planar light source device 200 may include the diffusion plate 3. The diffusion plate 3 has a thin-plate shape. The reflection unit 6 has a reflection surface thereinside. The diffusion plate 3 is disposed at the liquid crystal display element side (+z-axis direction) relative to the reflection unit 6. The diffusion plate 3 is disposed in the +z-axis direction with respect to an opening 66. The diffusion plate 3 is disposed so as to cover the opening 66.

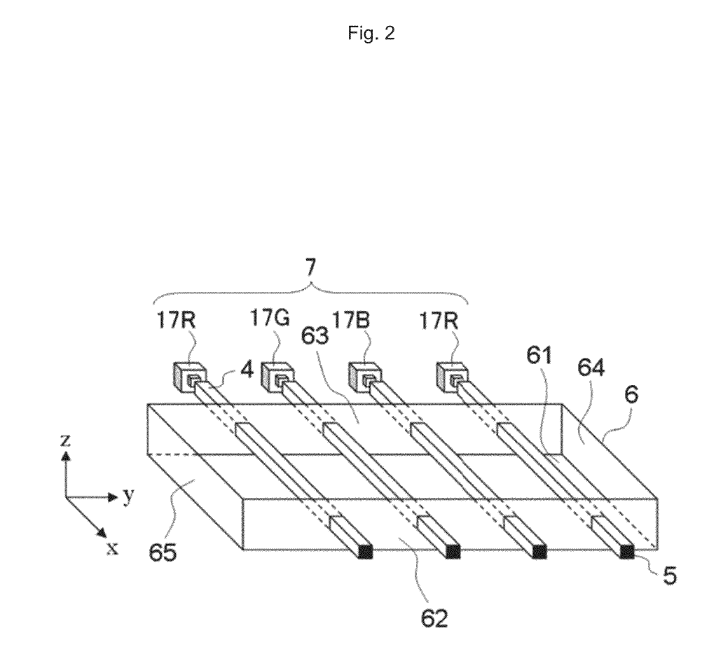

FIG. 2 is a perspective view explaining the inside of reflection unit 6. The reflection unit 6 has a base plate 61, side plates 62, 63, 64, 65, and the opening 66. The reflection unit 6 has a box-like shape. The base plate 61 is a plate-like portion parallel to the x-y plane. The side plates 62, 63 are plate-like portions parallel to the y-z plane. The side plate 62 faces the side plate 63. The side plates 64, 65 are plate-like portions parallel to the z-x plane. The side plate 64 faces the side plate 65. The opening 66 is an opening portion disposed in the normal direction to the base plate 61. The opening 66 faces the base plate 61.

The base plate 61 is a plane having a size equal to or less than that of the display screen 1a of liquid crystal display element 1. The side plate 62 is disposed at an end portion of the base plate 61 in its +x-axis direction. The side plate 63 is disposed at an end portion of the base plate 61 in its −x-axis direction. The side plate 64 is disposed at an end portion of the base plate 61 in its +y-axis direction. The side plate 65 is disposed at an end portion of the base plate 61 in its −y-axis direction.

Each inner surface of reflection unit 6 is a light reflection surface. “Inner surface” means an inside surface of the reflection unit 6 having the box-like shape. That is, the reflection surfaces are a surface of base plate 61 in its +z-axis direction, a surface of side plate 62 in its −x-axis direction, a surface of side plate 63 in its +x-axis direction, a surface of side plate 64 in its −y-axis direction, and a surface of side plate 65 in its +y-axis direction. The reflection surface may be configured by a resin-based light reflection sheet, such as polyethylene terephthalate, provided at the inner surface of reflection plate. The reflection surface may be a light reflection surface made by depositing metal on the inner surface of reflection unit 6.

The diffusion plate 3 is disposed at the +z-axis side of reflection unit 6. The diffusion plate 3 is disposed at the +z-axis direction of opening 66. The diffusion plate 3 is disposed so as to cover the opening 66. The reflection unit 6 and the diffusion plate 3 configure a hollow box-like shape composed of the reflection surfaces and diffusion surface.

The light guide rods 4 are disposed so as to penetrate the inside of hollow box in its x-axis direction. The light guide rods 4 are disposed at a portion enclosed by the base plate 61 and the side plates 62, 63, 64, 65. That is, the light guide rods 4 are disposed at a portion enclosed by the reflection surfaces. Specifically, the side plates 62, 63 have holes each having a size same as that of an end portion of light guide rod 4 in its x-axis direction. Each hole, for inserting the light guide rod 4, disposed at the side plate 62 has the same coordinate on the y-z plane with the corresponding hole disposed at the side plate 63. Each light guide rod 4 is inserted through the holes provided at the side plates 62, 63 to be attached to the reflection unit 6. A light incident surface 41 of light guide rod 4 is disposed at the −x-axis side relative to the side plate 63. A surface 42 facing the light incident surface 41 is disposed at the +x-axis side relative to the side plate 62.

The laser light source 7 is disposed in the −x-axis direction with respect to the side plate 63. The laser light source 7 is disposed so as to face the light incident surface 41. The laser light source 7 is disposed so that a light emitting part thereof directs the +x-axis direction. That is, the laser light source 7 emits laser light in the +x-axis direction. In the laser light source 7, a plurality of laser emitting elements 17 is arranged in a line in the y-axis direction. The laser light source 7 is configured with different kinds of laser emitting elements 17 that emit different colors of light, so as to generate white light. The laser light source 7 is disposed at the lower end of planar light source device 200. That is, the laser light source 7 is disposed below the liquid crystal display device 100. Reference numeral “17” of the laser emitting element 17 is used when laser emitting elements 17R, 17G, 17B are referenced collectively.

In Embodiment 1, the laser emitting elements 17 are provided each emitting monochromatic light of red, green, or blue. The laser emitting elements 17 include the red laser emitting element 17R, green laser emitting element 17G, and blue laser emitting element 17B. Three kinds of laser emitting elements 17 are arranged at equal intervals along the y-axis direction. Three colors of laser emitting elements 17 are arranged, for example, in the order of red, green, and blue.

As shown in FIG. 2, each of the laser emitting elements 17R, 17G, 17B has its dedicated light guide rod 4. The light emitting part of laser emitting element 17 is disposed so as to face the light incident surface 41 of light guide rod 4. Laser light 71 projected from the laser emitting element 17 in the +x-axis direction enters the light guide rod 4 through the light incident surface 41 of light guide rod 4. The laser light 71 propagates in the +x-axis direction while being totally reflected at the interface between the light guide rod 4 and airspace. That is, the laser light 71 travels through the inside of light guide rod 4 toward the surface 42. The surface 42 is a surface facing the light incident surface 41. After arriving at the surface 42, the laser light 71 is reflected by a reflection end portion 5 and propagates in the −x-axis direction while being totally reflected at the interface between the light guide rod 4 and the airspace. The reflection end portion 5 is a reflection surface attached to the surface 42.

For example, the light guide rod 4 contains a diffusion material 10. The light guide rod 4 is, for example, a square-pole shape rod of about five millimeters square. The laser light 71 travels through the inside of light guide rod 4 in the +x-axis direction while being totally reflected at the interface between the light guide rod 4 and the airspace. However, when the laser light 71 enters the diffusion material 10, the laser light 71 is diffusely reflected by the diffusion material 10 and the travelling direction thereof is changed. If the travelling direction of laser light 71 is changed, some part of the laser light 71 does not satisfy the total reflection condition at the interface between the surface of light guide rod 4 and the airspace. Such a part of the laser light 71, which does not satisfy the total reflection condition, is projected from the light guide rod 4 to the outside of the light guide rod 4.

The light guide rod 4 contains a transparent material and a material (diffusion material 10) having a refractive index higher than that of the transparent material. The light guide rod 4 is designed so that the laser light projected from the light guide rod 4 has a uniform intensity distribution in the x-axis direction and has a liner shape. That is, the laser light is liner-shaped light having a uniform intensity distribution in the length direction of light guide rod 4.

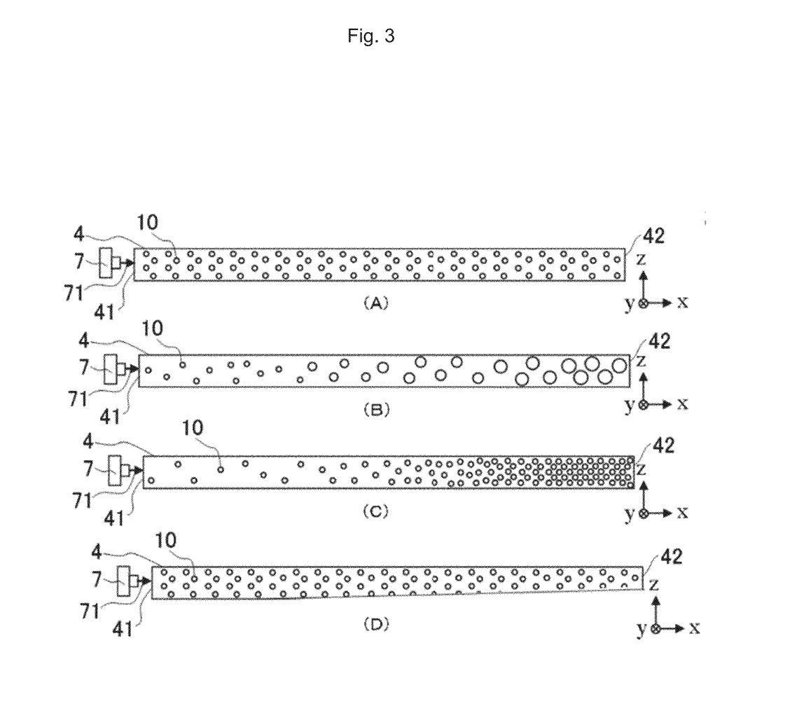

FIG. 3 is a schematic diagram schematically showing a configuration of the light guide rod 4. In the light guide rod 4 shown in (A) in FIG. 3, the diffusion material 10 granules each having the same size are evenly disposed at the inside of light guide rod 4. In the light guide rod 4 shown in (B) in FIG. 3, the diffusion materials 10 granules having different sizes are disposed at the inside of light guide rod 4. The size of diffusion material 10 granule is smaller at the light incident surface 41 side and larger at the surface 42 side. In the light guide rod 4 shown in (C) in FIG. 3, the diffusion material 10 granules each having the same size are disposed at the inside of light guide rod 4 with the number thereof per unit volume being changed. The number of diffusion material 10 granules per unit volume is smaller at the light incident surface 41 side and larger at the surface 42 side. In the light guide rod 4 shown in (D) in FIG. 3, the diffusion material 10 granules each having the same size are evenly disposed at the inside of light guide rod 4. The cross-sectional area of light guide rod 4 shown in (D) in FIG. 3 is larger at the light incident surface 41 side and smaller at the surface 42 side.

For example, by adjusting the size of each diffusion material 10 granule as shown in (A) in FIG. 3, uniform and liner-shaped light can be obtained. In addition, by adjusting the quantity of diffusion material 10, uniform and liner-shaped light can be obtained. That is, in a case shown in (A) in FIG. 3, concentration of diffusion material 10 per unit volume in the light guide rod 4 is set to be a predetermined value. Here, “concentration” means the ratio of diffusion material 10 per unit volume. “High concentration” means that the ratio of diffusion material 10 per unit volume is large. “Low concentration” means that the ratio of diffusion material 10 per unit volume is small. The concentration is selected so that the laser light 71 becomes even in the x-axis direction of light guide rod 4. That is, it is not necessary to change the concentration of diffusion material 10 in accordance with each position in the x-axis direction of light guide rod 4. For example, if the concentration of diffusion material 10 is made high, the laser light 71 at the neighborhood of light incident surface 41 becomes bright. On the other hand, if the concentration of diffusion material 10 is made low, the laser light 71 at the neighborhood of surface 42 becomes bright. Based on the above, it is understood that the laser light 71 becomes even in the x-axis direction of light guide rod 4 by setting the concentration of diffusion material 10 to be the predetermined value.

For example, as shown in (B) in FIG. 3, uniform and liner-shaped light can be obtained by changing the size of diffusion material 10 granule in accordance with each position in the x-axis direction of light guide rod 4. In this case, the size of diffusion material 10 granule becomes large from −x-axis direction toward +x-axis direction.

Also, as shown in (C) in FIG. 3, uniform and liner-shaped light can be obtained by changing the quantity of diffusion material 10 in accordance with each position in the x-axis direction of light guide rod 4. In this case, the quantity of diffusion material 10 becomes large from −x-axis direction toward +x-axis direction. Here, “quantity” means the number of material per unit volume.

In addition, as shown in (D) in FIG. 3, the light guide rod 4 may have, for example, a shape in which the cross-sectional area thereof becomes small as coming close to the surface 42 from the light incident surface 41. The surface 42 is a surface facing the light incident surface 41. While the diffusion material 10 granules each having the same size are evenly disposed in (D) in FIG. 3, the diffusion material 10 granules having different sizes may be disposed, similar to the case shown in (B) in FIG. 3. Also, the diffusion material 10 may be disposed with changing the number thereof per unit volume, similar to the case shown in (C) in FIG. 3.

As the transparent material, for example, an acryl resin (PMMA) or the like is used. Also, for example, types of diffusion material 10 may be changed in accordance with each position in the x-axis direction of light guide rod 4. In this case, the type of diffusion material 10 changes from low reflection one to high reflection one as moving from −x-axis direction toward +x-axis direction. That is, the type of diffusion material 10 changes from low reflection one to high reflection one as moving from the light incident surface 41 toward the surface 42.

The laser light 71 diffusely reflected at the inside of light guide rod 4 spreads toward the inside of reflection unit 6. The laser light 71 that reaches the base plate 61 and side plates 62, 63, 64, 65 is reflected by the reflection surface of base plate 61 and the reflection surfaces of side plates 62, 63, 64, 65. The laser light 71 travels the inside of reflection unit 6 while changing its traveling direction. Similarly, the laser light 71 projected from the neighboring light guide rod 4 travels the inside of reflection unit 6. At that time, the laser light 71 projected from one light guide rod 4 spatially overlaps with the laser light 71 projected from the other, while traveling the inside of reflection unit 6. Note that, while mirror reflection surfaces can be employed as the reflection surface of base plate 61 and the reflection surfaces of side plates 62, 63, 64, 65, diffusion reflection surfaces may be also employed. If the diffusion reflection surfaces are employed, the laser light 71 is diffusely reflected so that spatial overlapping of laser light 71 is promoted.

In the laser light source 7 in Embodiment 1, the red laser emitting element 17R, green laser emitting element 17G, and blue laser emitting element 17B are arranged in this order. The light guide rod 4 is provided for each of the laser emitting elements 17. That is, in the reflection unit 6, each laser light 71 projected from the light guide rod 4 becomes red liner-shaped light, green liner-shaped light, or blue liner-shaped light. The laser light 71 projected from one light guide rod 4 spatially overlaps with the laser light 71 projected from the other, while traveling the inside of reflection unit 6. Thus, the red light, green light, and blue light are mixed. Further, after reflected by the base plate 61 and side plates 62, 63, 64, 65 in the reflection unit 6, the laser light 71 travels in the +z-axis direction and is diffused by the diffusion plate 3. After diffused by the diffusion plate 3, the laser light 71 is projected from the planar light source device 200 as white light in which the red light, green light, and blue light are mixed.

The laser light 71 projected from the diffusion plate 3 transmits through the optical sheet 2 and projects the rear surface 1b of liquid crystal display element 1. The optical sheet 2 has a function of directing the laser light 71 to the direction toward the rear surface 1b of liquid crystal display element 1 (+z-axis direction).

For example, semiconductor lasers are used as the laser emitting elements 17 configuring the laser light source 7. Depending on its structure, a semiconductor laser has a fast axis direction having a larger spread angle and a slow axis direction having a smaller spread angle. The slow axis direction is perpendicular to the fast axis direction. In the arrangement of laser emitting elements 17 in Embodiment 1, the fast axis direction is parallel to the arranging direction (y-axis direction) of laser emitting elements 17. The slow axis direction is parallel to the thickness direction (z-axis direction) of reflection unit 6.

By arranging the laser emitting elements 17 so that their fast axis direction is parallel to the arranging direction (y-axis direction) of laser emitting elements 17, the laser light 71 projected from the light guide rod 4 spreads wider in the y-axis direction. Thus, the laser light can be easily mixed in the reflection unit 6 with the other laser light projected from the neighboring light guide rod 4. Also, the thickness of reflection unit 6 (z-axis direction) can be reduced. Note that the arranging direction of laser emitting elements 17 should not be limited to the above.

The laser light source 7 in Embodiment 1 is disposed at the lower side (−x-axis direction) of liquid crystal display element 1. The laser light source 7 generates heat while emitting light. The heat generated by the emission of laser light source 7 warms the air around the light source. The warmed air rises in the upper direction (+x-axis direction) of liquid crystal display element 1. The amount and the wavelength of light projected from the laser emitting element 17 are liable to vary depending on the temperature. By arranging the laser light source 7 at the lower side of liquid crystal display element, a rise in temperature around the laser light source 7 can be suppressed. The reason is that the warmed air around the laser light source 7 does not stay there and rises, and that low temperature air flows into an area around the laser light source 7 from the surroundings. In addition, by arranging the laser light source 7 at the lower side (−x-axis direction) of liquid crystal display element in a line, generation of temperature difference between the laser emitting elements 17 configuring the laser light source 7 can be prevented. Therefore, variation of emission among the respective laser emitting elements 17 caused by the temperature rise can be suppressed.

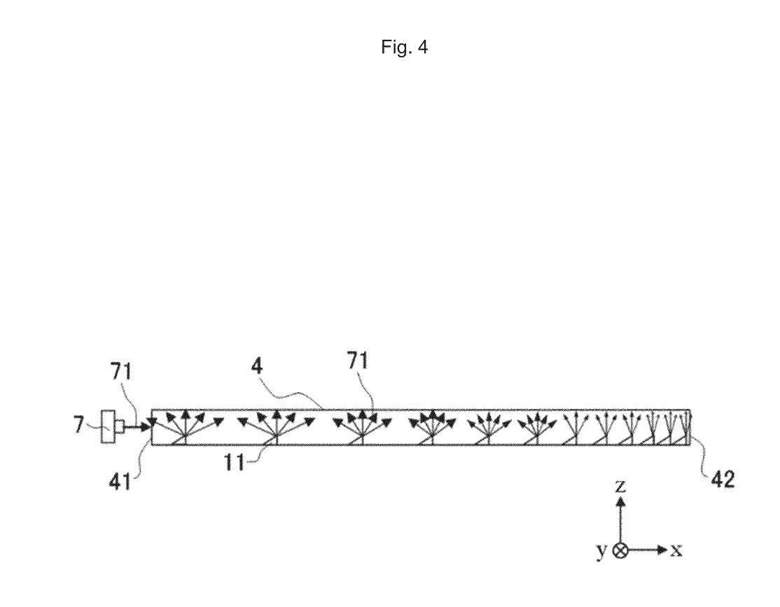

In Embodiment 1, a configuration is employed in which the light guide rod 4 has the transparent material and the diffusion material 10. However, the embodiment should not be limited thereto. FIG. 4 is a schematic diagram schematically showing a configuration of light guide rod 4. The light guide rod 4 shown in FIG. 4 has prism-shaped portions 11. The prism-shaped portions 11 are arranged in the x-axis direction. For example, as shown in FIG. 4, the prism-shaped portions 11 may be provided in a square-pole rod configured only with the transparent material. In FIG. 4, the prism-shaped portions 11 are provided on a surface in the −z-axis direction. However, a configuration may be employed in which the prism-shaped portions 11 are provided on another surface other than the light incident surface 41 and surface 42. The surface 42 is a surface facing the light incident surface 41. The interval between the neighboring prism-shaped portions 11 is larger at the light incident surface 41 side and smaller at the surface 42 side. By adjusting the arrangement density of prism-shaped portions 11 so as to change from sparse to thick as moving from the −x-axis direction toward the +x-axis direction, uniform and liner-shaped light can be obtained.

The light guide rod 4 is assumed to be a square-pole shape rod of about five millimeters square. However, this is not a limitation. For example, the light guide rod 4 may have a cylindrical shape whose light incident surface 41 is a circle. Also, it may be a rod whose light incident surface 41 has a rectangular or ellipsoidal shape. Note that, if the light incident surface 41 has the rectangular or ellipsoidal shape, it is desirable that the long side of rectangle or the long axis of ellipse is arranged to be parallel to the fast axis direction of laser.

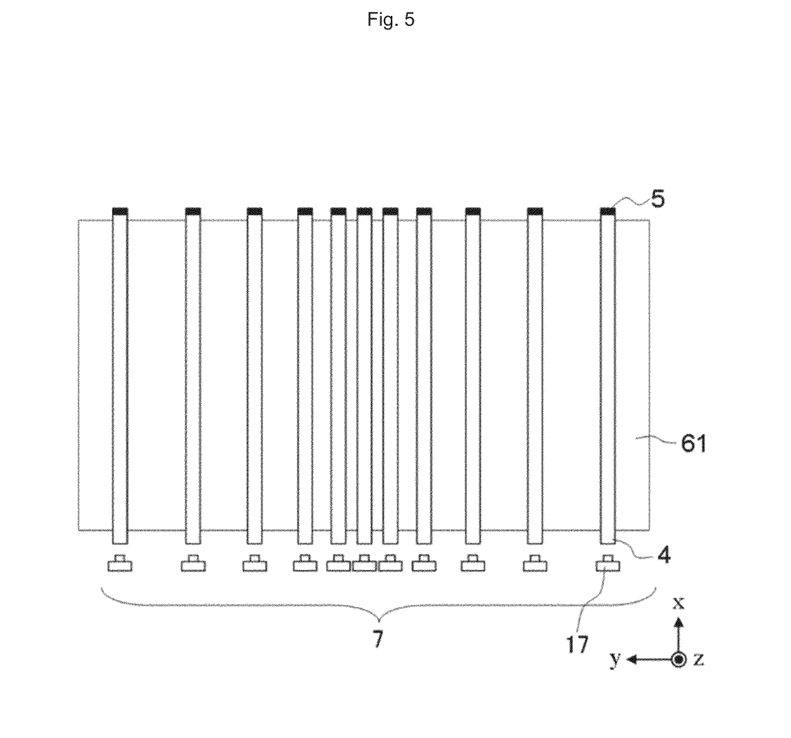

The light guide rods 4 and the laser light sources 7 are arranged with equal intervals in the y-axis direction. However, Embodiment 1 should not be limited to this. FIG. 5 is a schematic diagram schematically showing a layout of the light guide rods 4 and the laser light sources 7. For example, as shown in FIG. 5, the light guide rods 4 and the laser emitting elements 17 around the center portion of display screen 1a may be densely disposed compared to those around the end portions of display screen 1a. In FIG. 5, “end portion” means the end portions in the y-axis direction. By employing such a disposition, brightness at the center portion of display screen 1a can be increased in the liquid crystal display device 100.

In the laser light source 7 in Embodiment 1, the red laser emitting element 17R, green laser emitting element 17G, and blue laser emitting element 17B are arranged in this order. And the light guide rod 4 is assumed to be provided for each of the laser emitting elements 17. However, this is not a limitation. The red laser light, green laser light, and blue laser light may enter the single light guide rod 4. By employing such a configuration, three colors of laser light 71 are mixed while propagating through the light guide rod 4 and thus liner-shaped white light can be obtained.

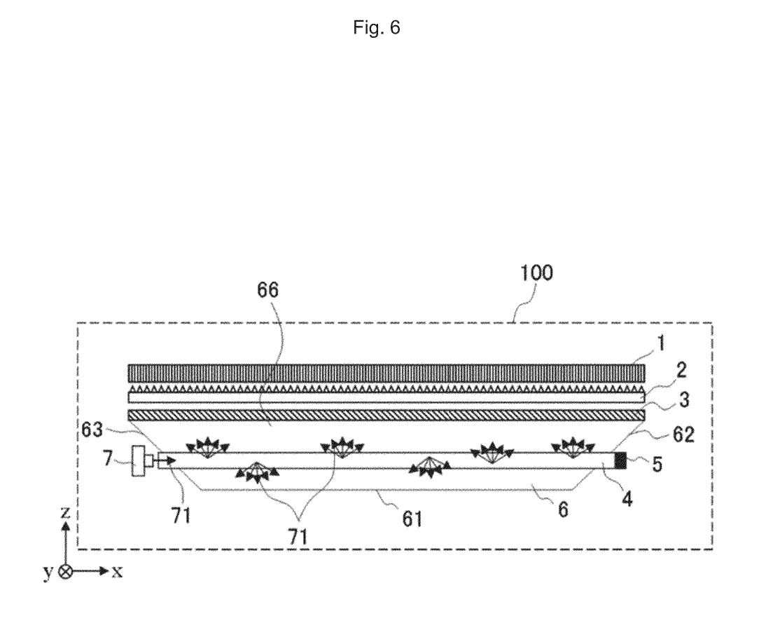

As shown in FIG. 6, the length of base plate 61 in reflection unit 6 in the x-axis direction may be shorter than the length of opening 66 in the x-axis direction. FIG. 6 is a configuration diagram schematically showing a configuration example of the liquid crystal display device 100. In this case, the side plates 62, 63 are configured to be slanted with respect to the x-y plane. In FIG. 6, the length of base plate 61 in the x-axis direction is shorter than the length of opening 66 in the x-axis direction. The side plate 62 is slanted to rotate clockwise when viewed from the −y-axis direction. The side plate 63 is slanted to rotate counterclockwise when viewed from the −y-axis direction. In this way, the laser light directed to the slanted side plates 62, 63 is reflected toward the direction of opening 66 (+z-axis direction).

Therefore, the circumferential portion of display screen 1a can be made brighter. By employing the slanted side plates 62, 63, the laser light source 7 can be disposed at the rear surface side (−z-axis direction) of diffusion plate 3, as shown in FIG. 6. Thus, a narrowed bezel can be obtained. “Disposing the laser light source 7 at the rear surface of diffusion plate 3” means that the laser light source 7 does not protrude out of the end surfaces of diffusion plate 3 in the x-axis direction. Or, it means that only a part of laser light source 7 protrudes out of the end surfaces of diffusion plate 3 in the x-axis direction.

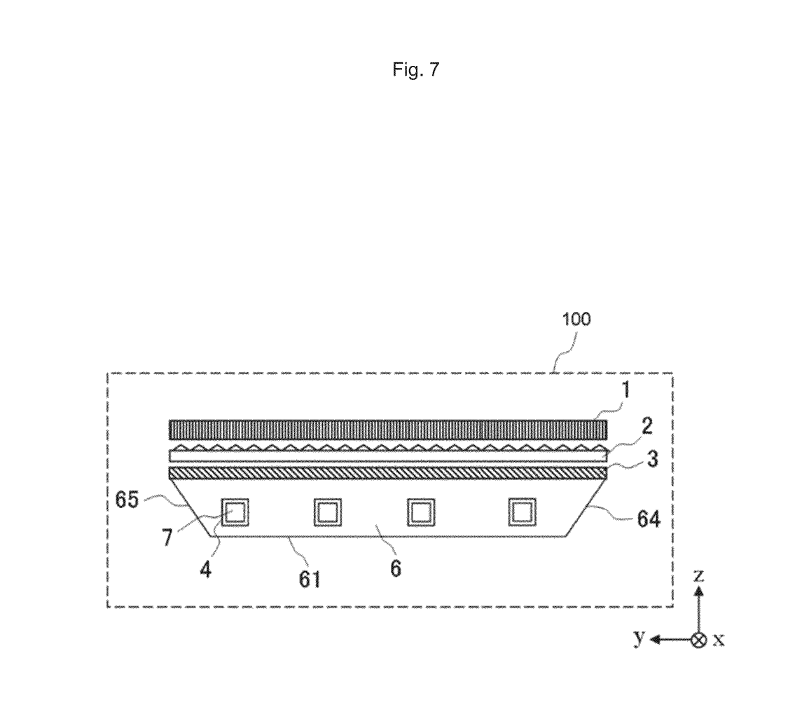

As shown in FIG. 7, the length of base plate 61 in reflection unit 6 in the y-axis direction may be shorter than the length of opening 66 in the y-axis direction. FIG. 7 is a configuration diagram schematically showing a configuration example of the liquid crystal display device 100. In this case, the side plates 64, 65 are configured to be slanted with respect to the x-y plane. The side plate 64 is slanted to rotate clockwise when viewed from the −x-axis direction. The side plate 65 is slanted to rotate counterclockwise when viewed from the −x-axis direction. In this way, the laser light 71 directed to the slanted side plates 64, 65 is reflected toward the direction of opening 66 (+z-axis direction). Therefore, the circumferential portion of display screen 1a can be made brighter, and thus, brightness at the circumferential portion of display screen 1a can be increased.

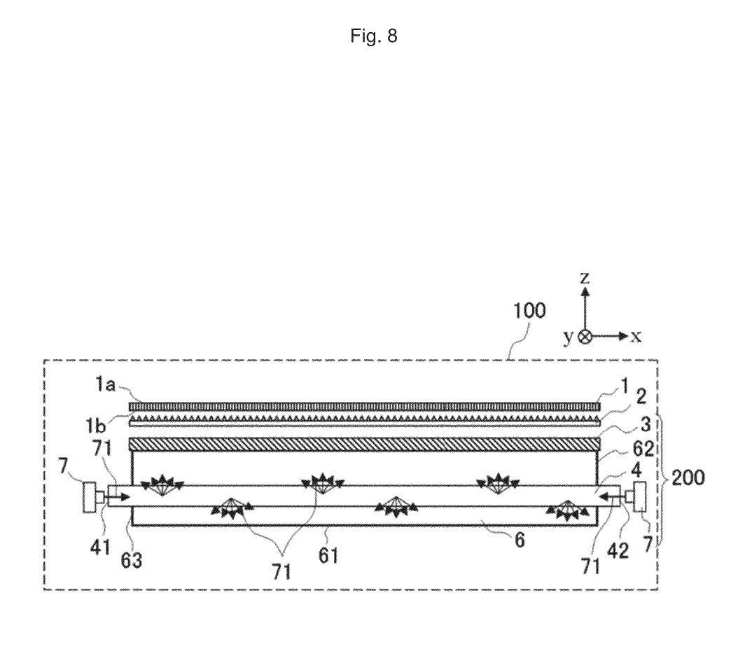

In Embodiment 1, the laser light source 7 is disposed at the lower end portion of liquid crystal display element 1. “Lower end portion” means the end portion in the −x-axis direction. However, as shown in FIG. 8, the laser light sources 7 may be disposed at both of the lower end portion and the upper end portion of liquid crystal display element 1. FIG. 8 is a configuration diagram schematically showing a configuration example of the liquid crystal display device 100. The laser light source 7 is disposed so as to face the light incident surface 41 of light guide rod 4. Since the surface 42 also serves as a light incident surface, the other laser light source 7 is disposed so as to face the surface 42 of light guide rod 4. The surfaces 41, 42 are surfaces parallel to the y-z plane. In this way, brightness of the liquid crystal display element 1 can be increased.

The planar light source device 200 in Embodiment 1 includes the light guide rod 4 for converting the laser light which is a point light source into the liner-shaped light. Therefore, light loss generated at light incident surfaces and light emission surfaces is reduced compared to that in a conventional configuration in which a plurality of optical elements are employed, and thus, high light utilization efficiency can be obtained.

As described above, according to the planar light source device 200 in Embodiment 1, it is possible to obtain sheet-like light having high light utilization efficiency and high uniformity in spatial light intensity distribution with a simple configuration, even though a laser is employed as a light source. The liquid crystal display device 100 in which the above-described planar light source device 200 is included can provide a high-quality image having a wide color reproduction range and suppressed unevenness in brightness.

In Embodiment 1, by disposing the light guide rods 4 within a range of light emission surface (opening 66) in the reflection unit 6, a narrowed bezel can be obtained. The light guide rod 4 is an optical element for converting the laser light 71 which is a point light source into uniform and liner-shaped light. The reflection unit 6 is disposed at the rear surface side (−z-axis direction) of liquid crystal display element 1.

The planar light source device 200 includes the laser light source 7, light guide rods 4, and reflection unit 6. The laser light source 7 emits the laser light 71. The light guide rod 4 having a rod shape has the light incident surface 41 at the end portion of rod shape in its longitudinal direction, and converts the laser light 71 entering through the light incident surface 41 into liner-shaped light. The reflection unit 6 has a box-like shape including the base plate 61, the side plates 62, 63, 64, 65 being connected to the base plate 61, and the opening 66 facing the base plate 61, and the inner surfaces of base plate 61 and side plates 62, 63, 64, 65 configure reflection surfaces. The light guide rods 4 are disposed at a portion enclosed by the reflection surface of base plate 61 and the reflection surfaces of side plates 62, 63, 64, 65. The liner-shaped light projected from the light guide rods 4 is reflected by the reflection surface of base plate 61 and the reflection surfaces of side plates 62, 63, 64, 65, and is projected through the opening 66.

The laser light source 7 is disposed at the lower end of reflection unit 6.

### Embodiment 2

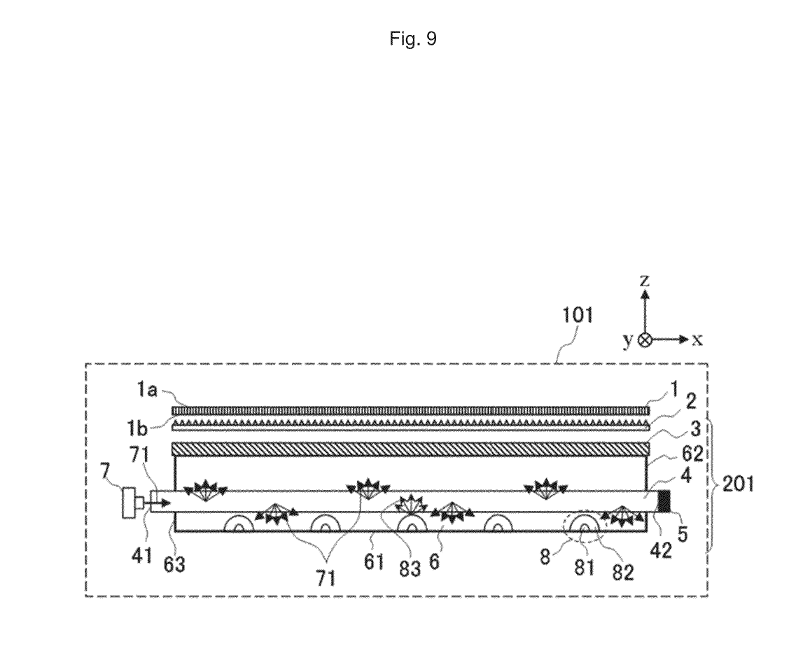

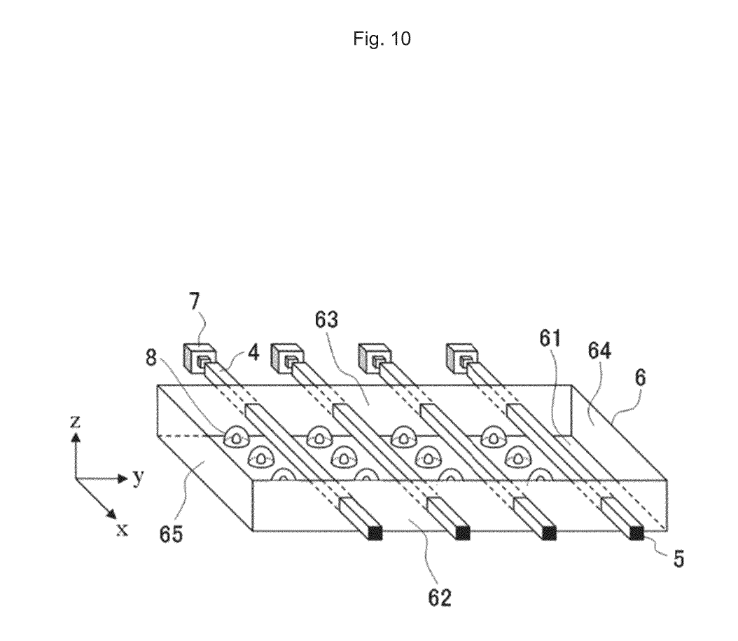

FIG. 9 is a configuration diagram schematically showing a configuration of a liquid crystal display device 101 (planar light source device 201 included) in Embodiment 2 according to the present invention. FIG. 10 is a perspective view explaining the inside of reflection unit 6. The planar light source device 201 in Embodiment 2 has a configuration in which LED light sources 8 are added to the planar light source device 200 in Embodiment 1. The LED light source 8 is configured with an LED 81 and a lens 82. That is, the planar light source device 201 has two kinds of different light sources, namely the laser light sources 7 and the LED light sources 8, which is the difference from the planar light source device 200.

Configuring elements same with or corresponding to those shown in Embodiment 1 are indicated by the same reference numerals, and the detailed explanation thereof will be skipped. Same or corresponding configuring elements are the liquid crystal display element 1, optical sheet 2, diffusion plate 3, light guide rods 4, reflection end portions 5, laser light sources 7, and the configuration of reflection unit 6 except that the LED light sources 8 are attached. That is, the same or corresponding configuring elements explained in Embodiment 1 are also employed in Embodiment 2.

White LEDs are currently used as light sources for liquid crystal display devices. A white LED generates white light having a wide spectrum, i.e. from blue to red. White LEDs have high luminous efficiency and are useful for reducing power consumption. Thus, they are commonly used as light sources for back light unit in liquid crystal display devices.

Color filters are provided in a liquid crystal display element of liquid crystal display device. In the liquid crystal display device, color representation is performed by extracting only each wavelength range of red, green, or blue using the color filter. For a light source having a continuous spectrum with a wide wavelength bandwidth such as the white LED, in order to broaden its color reproduction range, it is necessary that a wavelength bandwidth of light transmitting through the color filter is set to be narrow so as to increase the color purity of display color. However, if the wavelength bandwidth of light transmitting through the color filter is set to be narrow, an amount of unnecessary light increases. That is, efficiency for light utilization greatly decreases in the liquid crystal display element. This causes reduction of brightness in the display screen of liquid crystal display element. Further, this invites increase of power consumption in the liquid crystal display device.

In Embodiment 2, the liquid crystal display device 101 having both a wide color reproduction range and low power consumption is obtained. Thus, the light source includes the LED light sources 8 and laser light sources 7. The LED light source 8 includes a blue LED and a fluorescent material. Specifically, the LED light source 8 is a light source package in which a blue LED chip emitting blue light is provided and a green fluorescent material that absorbs blue light and emits green light is filled. The LED light source 8 further includes the LED 81 which emits bluish-green light and the lens 82. The LED 81 is the package in which the blue LED chip emitting blue light is provided and the green fluorescent material that absorbs blue light and emits green light is filled. The lens 82 broadens a spread angle of light emitted from the LED 81. “Spread angle” is an angle of broadened light. The laser light source 7 includes the laser emitting element 17R which emits red light.

As the LED 81, a bluish-green LED is employed in which a monochromatic blue LED and a fluorescent material that absorbs blue light and emits green light are provided. The reason is that a monochromatic LED or laser which emits green light and which is small enough to be applicable to a display device is inferior to the bluish-green LED in terms of low power consumption and high output power.

Humans have high sensitivity for a color difference in red. Therefore, the humans visually feel the difference in wavelength bandwidth in red as a significant difference. Here, the difference in wavelength bandwidth is a difference in color purity. A white LED used as a light source for a conventional liquid crystal display device has a small amount of red spectrum energy in a bandwidth especially between 600 nm and 700 nm. That is, if color purity at a wavelength range between 630 nm and 640 nm which is favorable for pure red is increased by using a color filter having a narrow wavelength bandwidth, an amount of transmitting light is greatly reduced and efficiency for light utilization decreases. Thus, a problem occurs that the brightness significantly decreases.

On the other hand, since the laser emitting element 17 has a narrow wavelength bandwidth, light having high color purity can be obtained with reduced loss of light. Especially, from among three primary colors, if the laser emitting element 17 having high monochromaticity is used for red light, effects for reducing power consumption and improving color purity increase. Thus, a light source emitting red light is employed as the laser light source 7 in the liquid crystal display device 101 in Embodiment 2.

As shown in FIG. 10, the bluish-green LED light sources 8 are bidimensionally arranged on the base plate 61, parallel to the x-y plane, in the reflection unit 6. That is, the LED light sources 8 are arranged at the inside of reflection unit 6 having a box-like shape. Bluish-green LED light 83 spatially overlaps with the neighboring LED light 83 at the inside of reflection unit 6. Further, the LED light 83 is also mixed with the liner-shaped laser light 71 projected from the light guide rod 4 at the inside of reflection unit 6. After mixed with the liner-shaped laser light 71, the LED light 83 becomes white light. Further, after diffused by the diffusion plate 3, the mixed white light is projected toward the rear surface 1b of liquid crystal display element 1 as sheet-like light having a uniform intensity distribution in the x-y plane.

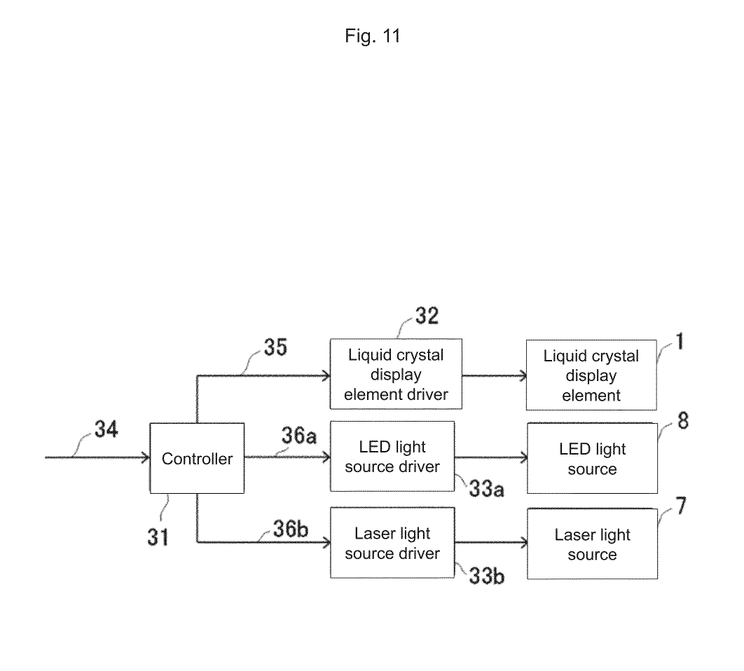

Power consumption can be reduced by separately controlling the luminescence amount of LED light source 8 and the luminescence amount of laser light source 7. FIG. 11 is a block diagram showing a driving method for the liquid crystal display element 1, LED light sources 8, and laser light sources 7. A liquid crystal display element driver 32 drives the liquid crystal display element 1. An LED light source driver 33a drives the LED light sources 8. A laser light source driver 33b drives the laser light sources 7. A controller 31 controls the liquid crystal display element driver 32, LED light source driver 33a, and laser light source driver 33b. The controller 31 receives an image signal 34. The controller 31 sends a liquid crystal display element control signal 35 to the liquid crystal display element driver 32. The controller 31 sends an LED light source control signal 36a to the LED light source driver 33a. The controller 31 sends a laser light source control signal 36b to the laser light source driver 33b.

For example, the controller 31 separately controls the LED light source driver 33a and the laser light source driver 33b. Thus, the controller 31 can adjust the ratio between the amount of bluish-green light projected from the LED light source 8 and the amount of red light projected from the laser light source 7. The percentage of light intensity necessary for each color differs depending on the image signal 34. If the controller 31 adjusts the luminescence amount of each of the light sources in accordance with the image signal 34, it is possible to reduce power consumption.

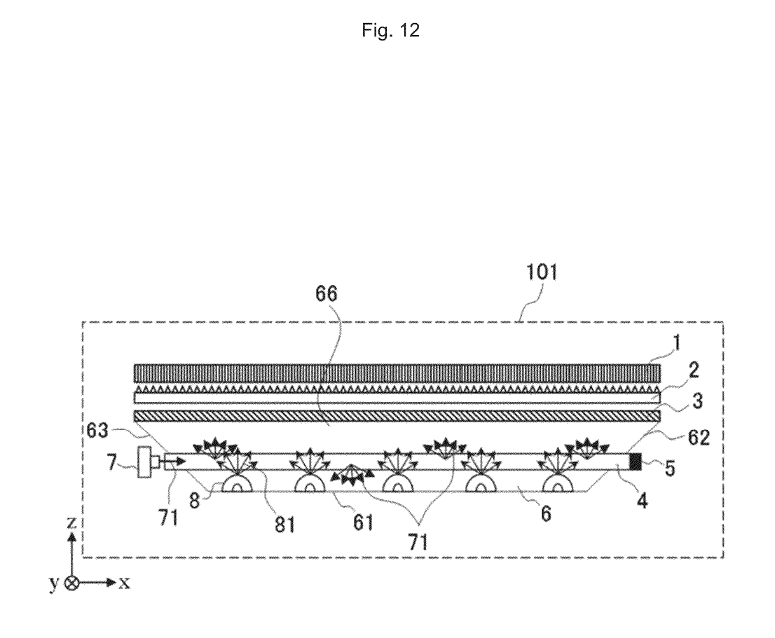

Similar to FIG. 6 in Embodiment 1, a configuration may be employed also in Embodiment 2 in which the side plates 62, 63 in reflection unit 6 are slanted with respect to the x-y plane, as shown in FIG. 12. FIG. 12 is a configuration diagram schematically showing a configuration example of the liquid crystal display device 101. The length of base plate 61 in the x-axis direction is shorter than the length of opening 66 in the x-axis direction. Thus, the laser light source 7 can be disposed at the rear surface side (−z-axis direction) of diffusion plate 3. Therefore, a narrowed bezel can be obtained. In addition, brightness at the circumferential portion of liquid crystal display element 1 can be increased. “Disposing the laser light source 7 at the rear surface of diffusion plate 3” means that the laser light source 7 does not protrude out of the end surfaces of diffusion plate 3 in the x-axis direction. Or, it means that only a part of the laser light source 7 protrudes out of the end surfaces of diffusion plate 3 in the x-axis direction.

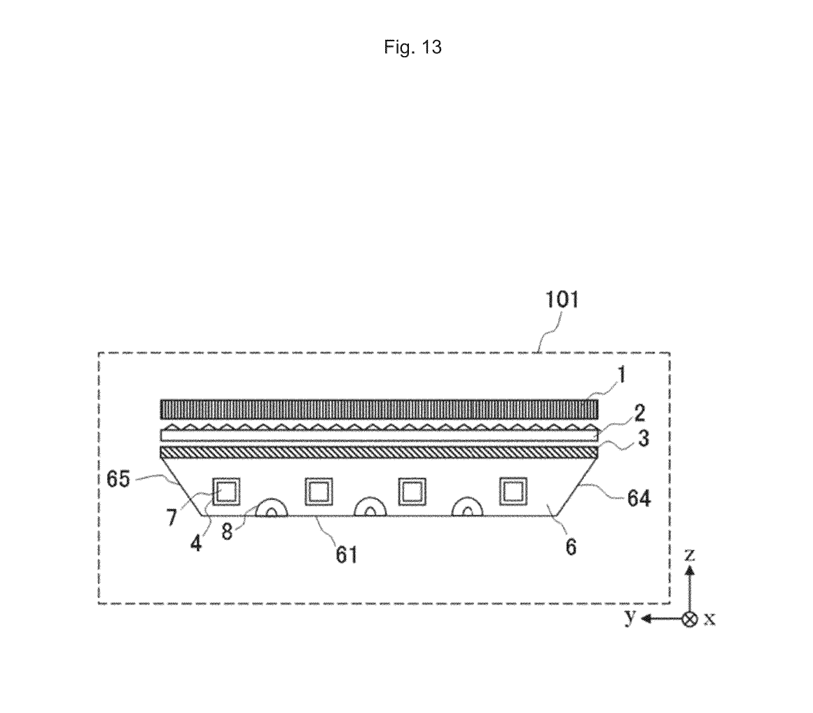

Similar to FIG. 7 in Embodiment 1, a configuration may be employed also in Embodiment 2 in which the side plates 64, 65 in reflection unit 6 are slanted with respect to the x-y plane, as shown in FIG. 13. FIG. 13 is a configuration diagram schematically showing a configuration example of the liquid crystal display device 101. The length of base plate 61 in the y-axis direction is shorter than the length of opening 66 in the x-axis direction. Thus, brightness at the circumferential portion of liquid crystal display element 1 can be increased. Note that, while each of the LED light sources 8 is disposed between the light guide rods 4 in the y-axis direction in FIG. 13, the present invention should not be limited to this. The LED light source 8 may be disposed in the −z-axis direction with respect to the light guide rod 4. That is, the light guide rod 4 and the LED light source 8 may be disposed so as to overlap in the y-axis direction when viewed from the +z-axis direction. In a case where the LED light source 8 is disposed in the −z-axis direction with respect to the light guide rod 4, if a prism sheet 91 or a diffusion sheet 92 shown in Embodiment 3 described later is used, the LED light 83 can be easily mixed with the laser light 71.

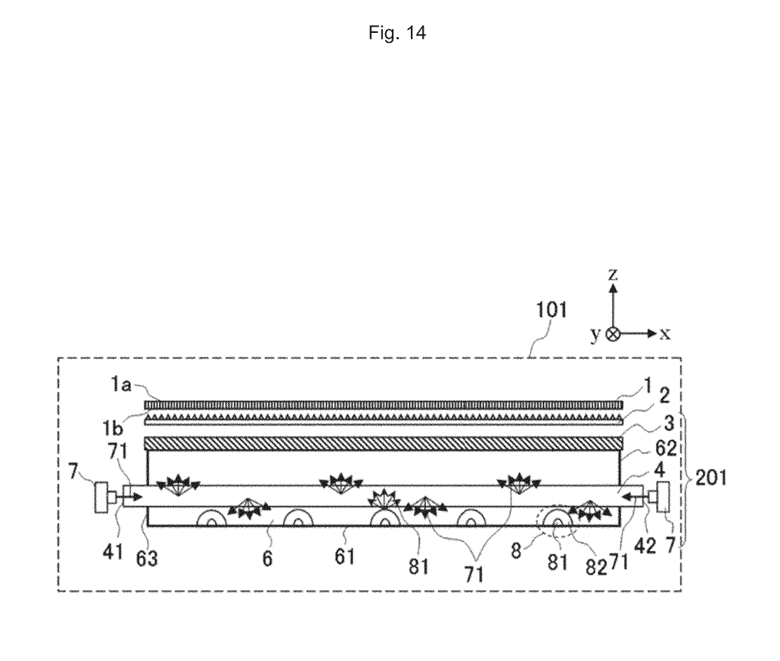

Similar to FIG. 8 in Embodiment 1, the laser light sources 7 may be disposed, also in Embodiment 2, at both of the lower end portion and the upper end portion of liquid crystal display element 1, as shown in FIG. 14. FIG. 14 is a configuration diagram schematically showing a configuration example of the liquid crystal display device 101. The laser light source 7 is disposed so as to face the light incident surface 41 of light guide rod 4. Since the surface 42 also serves as a light incident surface, the other laser light source 7 is disposed so as to face the surface 42 of light guide rod 4. The surfaces 41, 42 are surfaces parallel to the y-z plane. In this way, brightness of the liquid crystal display element 1 can be increased. By employing the above-described configurations, effects similar to those explained in Embodiment 1 can be obtained.

In Embodiment 2, while a configuration of employing the laser light sources 7 which emit red light and the LED light sources 8 which emit bluish-green light is shown, the present invention should not be limited thereto. For example, it is possible that the laser light sources 7 are configured with the laser elements each emitting red light or blue light and the LED light sources 8 are configured with LED elements which emit green light. Also, for example, it is possible that the laser light sources 7 are configured with the laser elements which emit blue light and the LED light sources 8 are configured with LED elements each emitting red light or green light. Note that a significant difference against a conventional liquid crystal display device can be shown in a case where the red laser light sources are only employed, rather than a case where the blue laser light sources are only employed. The reason is that, as described above, the humans have high sensitivity for a color difference in red.

As described above, according to the planar light source device 201 in Embodiment 2, it is possible to obtain sheet-like light having high light utilization efficiency and high uniformity in spatial light intensity distribution with a simple configuration, even though a laser is employed as a light source. The liquid crystal display device 101 in which the above-described planar light source device 201 is included can provide a high-quality image having a wide color reproduction range and suppressed unevenness in brightness. In Embodiment 2, the light guide rods 4 and the LED light sources 8 are disposed at the inside of reflection unit 6 located at the rear surface side (−z-axis direction) of liquid crystal display element 1. Thus, narrowing of bezel (narrowed bezel) can be obtained. Further, since a configuration is employed in which the laser elements emit red light and the LED elements emit bluish-green light, a wide color reproduction range becomes compatible with low power consumption, which has been difficult in a conventional liquid crystal display device, and thus, it is possible to provide a liquid crystal display device with high productivity.

The planar light source device 201 includes the laser light source 7, light guide rods 4, and reflection unit 6. The laser light source 7 emits the laser light 71. The light guide rod 4 having a rod shape has the light incident surface 41 at the end portion of rod shape in its longitudinal direction, and converts the laser light 71 entering through the light incident surface 41 into liner-shaped light. The reflection unit 6 has a box-like shape including the base plate 61, the side plates 62, 63, 64, 65 being connected to the base plate 61, and the opening 66 facing the base plate 61, and the inner surfaces of base plate 61 and side plates 62, 63, 64, 65 configure reflection surfaces. The light guide rods 4 are disposed at a portion enclosed by the reflection surface of base plate 61 and the reflection surfaces of side plates 62, 63, 64, 65. The liner-shaped light projected from the light guide rods 4 is reflected by the reflection surface of base plate 61 and the reflection surfaces of side plates 62, 63, 64, 65, and is projected through the opening 66.

The laser light source 7 is disposed at the lower end of reflection unit 6.

The planar light source device 201 further includes the LED light sources 8 which emit the LED light 83 having a broader spread angle than that of the laser light 71. The LED light sources 8 are disposed on the inner surface of base plate 61. The LED light 83 projected from the LED light source 8 is reflected at the inside of reflection unit 6 and is projected through the opening 66.

### Embodiment 3

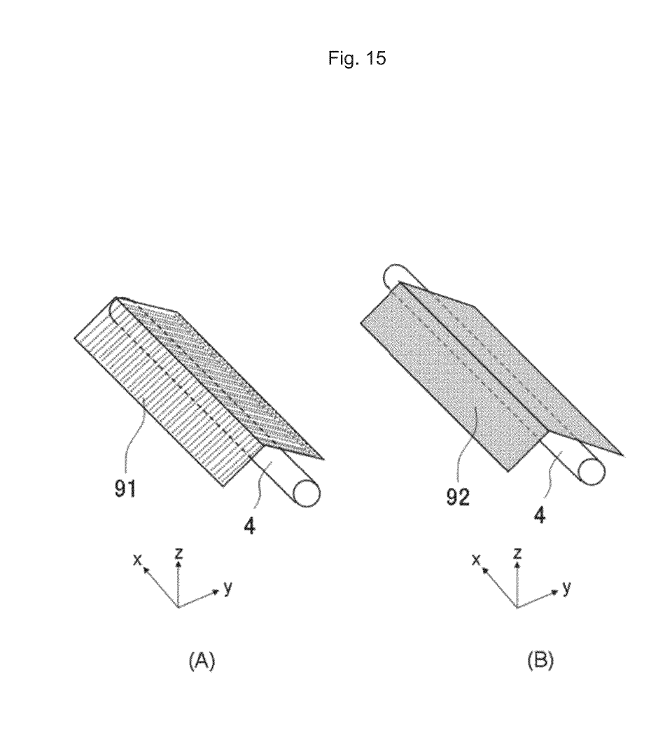

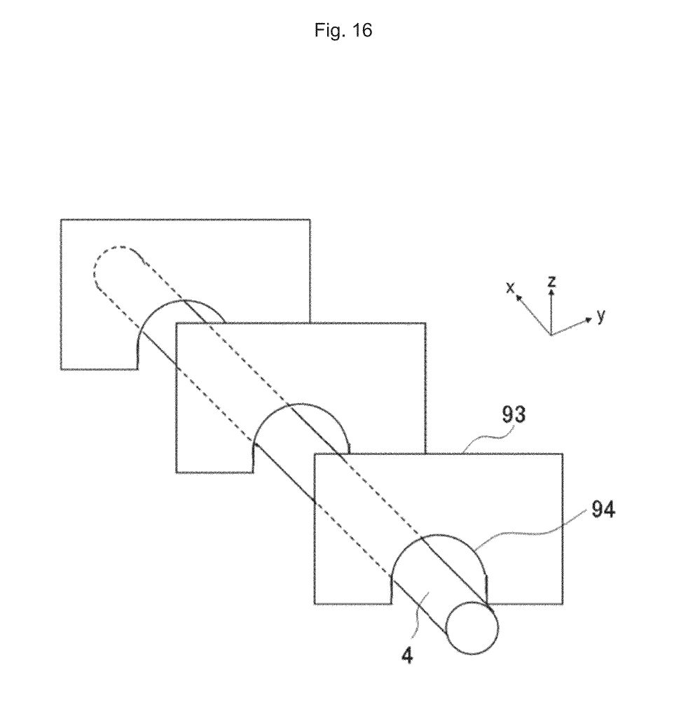

FIGS. 15 and 16 are diagrams schematically showing configurations for enhancing diffusibility of light projected from the light guide rod 4 shown in Embodiments 1 and 2 according to the present invention. The configurations can be added to the light guide rods 4 of the planar light source device 200 in Embodiment 1 and of the planar light source device 201 in Embodiment 2. By employing the configurations, it is possible to enhance diffusibility of light projected from the light guide rod 4. In addition, unevenness in brightness generated between the neighboring light guide rods 4 can be suppressed with a simple configuration. Thus, sheet-like light having a uniform intensity distribution can be easily obtained in the planar light source devices 200 and 201.

Configuring elements shown in Embodiment 1 or 2 are indicated by the same reference numerals, and the detailed explanation thereof will be skipped. Configuring elements, explained in Embodiment 3, same with those in Embodiment 1 or 2 are the light guide rods 4 and reflection unit 6. Also, the laser light sources 7 and laser light 71 are similar to those in Embodiment 1 or 2. That is, the same configuring elements explained in Embodiment 1 are also employed in Embodiment 3.

As described above, since the prism sheet 91, the diffusion sheet 92, or a reflection sheet 93 is added to the planar light source device 200 or 201 shown in Embodiment 1 or 2, Embodiment 3 can be applied to all the configurations shown in Embodiments 1 and 2. The prism sheet 91, diffusion sheet 92, and reflection sheet 93 are optical path changing members.

Laser light entering the light guide rod 4 is converted into liner-shaped light. At that time, depending on the disposing intervals between light guide rods 4 and the distance from the light guide rod 4 to the diffusion plate 3, unevenness in brightness is generated between the neighboring light guide rods.

Specifically, a portion on the diffusion plate 3 corresponding to the position where the light guide rod 4 is disposed is brightened. “Portion corresponding to the position where the light guide rod 4 is disposed” means a portion in the +z-axis direction with respect to the light guide rod 4. On the other hand, a portion on the diffusion plate 3 corresponding to the position between the neighboring light guide rods 4 is darkened. Thus, periodical unevenness in brightness is generated in the sheet-like light.

The unevenness in brightness can be suppressed by narrowing the disposing intervals between light guide rods 4. Also, the unevenness in brightness can be suppressed by lengthening the distance from the light guide rod 4 to the diffusion plate 3. However, if the disposing intervals between light guide rods 4 are narrowed, the number of light guide rods 4 and laser light sources increases. This detracts the ease of assembly due to the increase in parts count and thus causes the increase in cost. In recent years, flat-screen TVs have become popular. If the distance from the light guide rod 4 to the diffusion plate 3 is lengthened, the thickness of planar light source device 200 or 201 increases. This is not desirable for the liquid crystal display device from the standpoint of design. Here, “TV” means a form of liquid crystal display device.

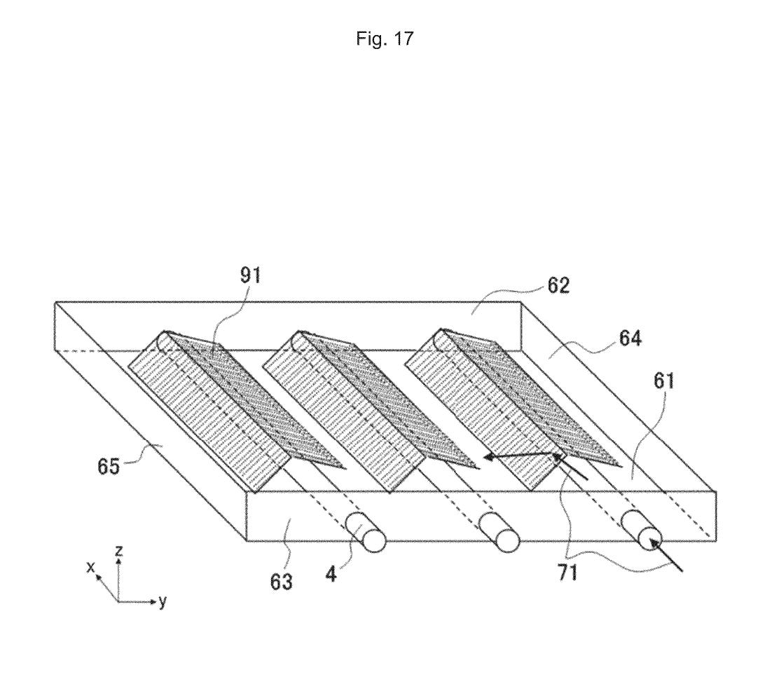

In Embodiment 3, these problems can be solved by adding a simple configuration. (A) in FIG. 15 is a diagram showing a case where the prism sheet 91 covers the opening 66 side (direction of diffusion plate 3) of light guide rod 4. FIG. 17 is a perspective view showing a case where the prism sheets 91 shown in (A) in FIG. 15 are applied to the light guide rods 4 attached to the reflection unit 6. Note that, while FIG. 17 shows a configuration of arranging three light guide rods 4, this is not a limitation. The prism sheet 91 in (A) in FIG. 15 is disposed with its prism surface being directed to the light guide rod 4 side. The prism sheet 91 in (A) in FIG. 15 is disposed so that the ridgeline of prism extends in the y-axis direction.

After entering the light guide rod 4, the laser light 71 is diffused by the diffusion material 10 while traveling through the inside of light guide rod 4 in the x-axis direction. The laser light is a beam having high straight-line stability. Therefore, most of the laser light 71 diffused by the diffusion material 10 or prism-shaped portion 11 travels in the x-axis direction after projected from the light guide rod 4. This is the difference between the light guide rod and the cold-cathode tube, described later. The cold-cathode tube emits liner-shaped light having a uniform intensity distribution at the time of emission. The light is diffused light and travels in all directions. On the other hand, in the laser light source 7 using the light guide rod 4, the laser light 71 is projected to the outside of light guide rod 4 by using the diffusion material 10 or prism-shaped portion 11. However, it is difficult to project the laser light 71 in all directions only by the diffusion material 10 or prism-shaped portion 11. Therefore, the optical path changing members such as prism sheet 91, diffusion sheet 92, and reflection sheet 93 are needed.

The laser light 71 projected from the light guide rod 4 is refracted in the y-axis direction by the prism sheet 91. The laser light 71 refracted by the prism sheet 91 transmits the prism sheet 91 and travels the inside of reflection unit 6. Thus, by refracting the laser light 71 which travels in the x-axis direction to the y-axis direction by the prism sheet 91, the liner-shaped light projected from the light guide rod 4 can be diffused. The prism sheet 91 shown in (A) in FIG. 15 is bent by a line parallel to the x-axis and located in the +z-axis direction with respect to the central axis of light guide rod 4. The end portions of prism sheet 91 in the y-axis direction are located in the −z-axis direction with respect to the bending position. In FIG. 17, the end portions of prism sheet 91 in the y-axis direction contact the inner surface of base plate 61. This is the simplest shape for covering the light guide rod 4 with the prism sheet 91.

(B) in FIG. 15 is a diagram showing a case where the diffusion sheet 92 covers the opening 66 side (direction of diffusion plate 3) of light guide rod 4. The light projected from the light guide rod 4 is diffused by the diffusion sheet 92 while transmitting through the diffusion sheet 92, and becomes light broadened in the x-y plane. The diffusion sheet 92 shown in (B) in FIG. 15 is bent by a line parallel to the x-axis and located in the +z-axis direction with respect to the central axis of light guide rod 4. The end portions of diffusion sheet 92 in the y-axis direction are located in the −z-axis direction with respect to the bending position. Similar to the prism sheet 91 shown in FIG. 17, the end portions of diffusion sheet 92 in the y-axis direction may be disposed so as to contact the inner surface of base plate 61. This is the simplest shape for covering the light guide rod 4 with the diffusion sheet 92.

It is desirable that the prism sheet 91 and diffusion sheet 92 are disposed so as to enclose the light guide rod 4. Thus, the traveling direction of laser light 71 projected from the light guide rod 4 can be directed to the direction perpendicular to the axis of light guide rod 4. In addition, in a case where the diffusion sheet 92 is used, diffusibility of laser light 71 is also improved. Since the laser light 71 is repeatedly reflected at the inside of reflection unit 6, uniformity of light in the planar light source device can be improved. Here, the laser light 71 projected in the opening 66 side is rarely reflected by the reflection surface of base plate 61 and the reflection surfaces of side plates 62, 63, 64, 65, and is often directly projected through the opening 66. Thus, it is desirable that the prism sheet 91 and diffusion sheet 92 are disposed at least at the opening 66 side relative to the light guide rod 4. By making the traveling direction of laser light 71 heading the opening 66 to be perpendicular to the diffusion plate 3 (z-axis direction), uniformity of sheet-like light can be improved. In addition, in a case where the diffusion sheet 92 is used, diffusibility of laser light 71 is improved and thus uniformity of sheet-like light can be improved.

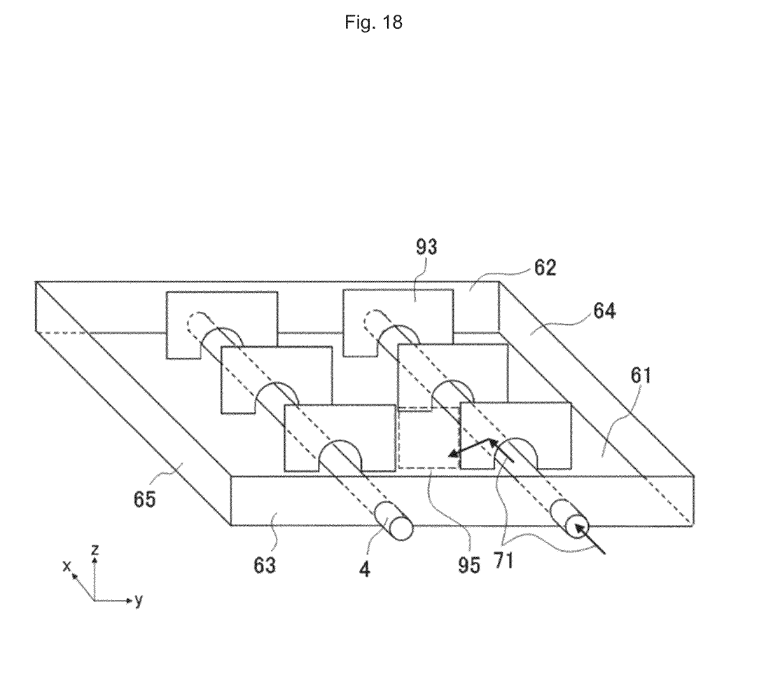

FIG. 16 is an example in which the reflection sheets 93 each having a cutout portion for inserting the light guide rod 4 are arranged with a constant interval in the x-axis direction. FIG. 18 is a perspective view showing a case where the reflection sheets 93 shown in FIG. 16 are applied to the light guide rods 4 attached to the reflection unit 6. The reflection sheets 93 are arranged parallel to the y-z plane. The reflection sheets 93 are arranged perpendicular to the base plate 61. By arranging the reflection sheets 93 perpendicular to the base plate 61, no shadow is generated at the inside of reflection unit 6 and thus uniform and sheet-like light can be easily generated. A plurality of reflection sheets 93 are arranged side by side in the x-axis direction. The end portion of reflection sheet 93 in the −z-axis direction has a cutout portion 94 for inserting the light guide rod 4. The cutout portion 94 is formed at the center position in the y-axis direction. In FIGS. 16 and 18, the cutout portion 94 has a U-shape having an opening portion in the −z-axis direction.

Note that, while the light guide rod 4 is inserted through the cutout portion 94 provided at the reflection sheet 93 in FIGS. 16, 18, and 19, the light guide rod 4 may be inserted through a hole provided at the reflection sheet 93. In addition, while a gap is provided between the cutout portion 94 and the light guide rod 4 in FIGS. 16, 18, and 19, a configuration without the gap may be employed. In the configuration without the gap, the traveling direction of laser light 71 projected from the light guide rod 4 can be immediately changed.

In FIG. 18, a reflection sheet 93 of one light guide rod 4 and a reflection sheet 93 of the neighboring light guide rod 4 are configured as separate members. The reason is that the light whose traveling direction has been changed by the reflection sheet 93 can be widely broadened to the inside of reflection unit 6. Each of the reflection sheets 93 is not necessarily configured as a separate member, and a similar effect can be obtained if an opening is provided so that the light can travel in the axis direction of light guide rod 2. Here, a gap and an opening are collectively called as “openings”. “Gap” is a small clearance between two things. Here, it means that there is a gap portion between the neighboring reflection sheets 93 since the reflection sheets 93 are configured as separate members. “Openings” mean that there is a hole. Here, it means that the neighboring reflection sheets 93 are formed as single member and a hole is provided at a position between the neighboring light guide rods 4. An opening 95 indicated by the broken line in FIG. 18 is a gap between the reflection sheets 93.

The laser light 71 projected from the light guide rod 4 travels in the x-axis direction and reflected by the reflection sheet 93. As described above, since the laser light has high straight-line stability, most of the laser light projected from the light guide rod 4 travels in the x-axis direction. The light traveling in the x-axis direction is reflected by the reflection sheet 93 and then travels in the y-axis direction or z-axis direction. By disposing the reflection sheets 93, it becomes easy to uniformly broaden the liner-shaped light projected from the light guide rod 4 to the inside of reflection unit 6. Also, a brightness difference (unevenness in brightness) between the neighboring light guide rods 4 can be reduced. That is, unevenness in brightness between the neighboring light guide rods 4 can be reduced. “Broaden the light projected from the light guide rod 4” means that the light projected from the light guide rod 4 travels without deviation. That is, it means that the inside of reflection unit 6 is filled with the light projected from the light guide rod 4 without deviation.

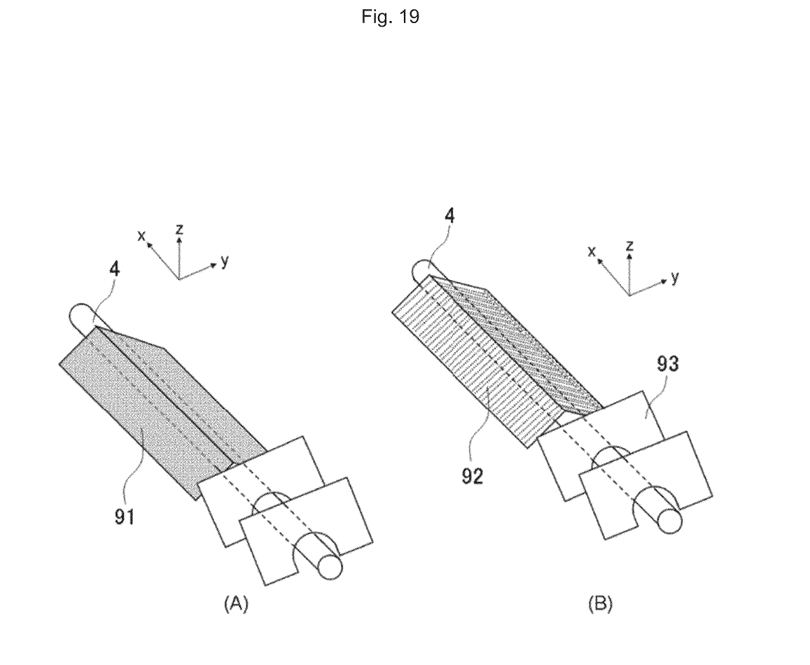

As shown in FIG. 19, a configuration may be employed in which two or more configurations from among those in (A) in FIG. 15, (B) in FIG. 15, and FIG. 16 are combined. FIG. 19 is a diagram schematically showing a configuration for enhancing diffusibility of light projected from the light guide rod 4. (A) in FIG. 19 shows a configuration in which the prism sheet and reflection sheets 93 are combined. (B) in FIG. 19 shows a configuration in which the diffusion sheet 92 and reflection sheets 93 are combined. Configurations described above in which a plurality of optical path changing members (prism sheet 91, diffusion sheet 92, and reflection sheet 93) is combined are collectively called as optical path changing portions. Note that an optical path changing member serves as an optical path changing portion if only one optical path changing member is included.

For example, when the traveling direction of light is changed, a larger bend angle is obtained by reflecting the light rather than refracting it. That is, a greater change in light traveling direction can be obtained by the reflection compared to the refraction. Since the laser light has a small spread angle, the light projected from the neighborhood of light incident surface 41 of light guide rod 4 is rarely broadened.

Here, “broadening of projected light” means an angle of projected light in its traveling direction with respect to the axis of light guide rod 4. Large broadening is obtained if the angle is large, and small broadening is obtained if the angle is small. That is, it is easy to broaden if the angle is large, and it is difficult to broaden if the angle is small.

As shown in FIG. 19, the reflection sheets 93 are disposed at the neighborhood of light incident surface 41 where projected light has small broadening and the projected light is reflected thereby so that the traveling direction of light is greatly changed and the light is broadened. That is, the reflection sheets 93 are disposed at the neighborhood of light incident surface 41 and the prism sheet 91 or diffusion sheet 92 is disposed at a position away from the light incident surface 41.

At the position, away from the light incident surface 41, where the broadening of projected light is relatively large, the light is broadened by using the diffusion sheet 92 or prism sheet 91. That is, by employing a configuration of refracting the projected light at the position away from the light incident surface 41, it becomes possible to broaden the light projected from the light guide rod 4 at a uniform intensity distribution.

In FIG. 19, the reflection sheets 93 are disposed non-parallel to the y-z plane. That is, the reflection sheets 93 are disposed non-perpendicular to the inner surface of base plate 6 (x-y plane). The reflection sheets 93 are disposed non-perpendicular to the axis of light guide rod 4. The reflection sheets 93 are disposed being slanted toward the +x-axis direction. That is, the reflection sheets 93 are disposed so as to be slanted toward the traveling direction of projected light.

As described above, the light projected from the neighborhood of light incident surface 41 of light guide rod 4 has a small angle in its traveling direction with respect to the axis of light guide rod 4. If the reflection sheets 93 are disposed parallel to the y-z plane at such a position, the projected light travels in the −x-axis direction and is not broadened.

By disposing the reflection sheets 93 so as to be slanted toward the traveling direction of projected light, the projected light travels at a large angle with respect to the axis of light guide rod 4. That is, broadening of projected light can be increased.

The reflection sheet 93 may be bent to have a U-shape. “Bend to have U-shape” can be realized by curving the sheet center and putting one end portion of the sheet close to the other. It is a shape in which both end portions of reflection sheet 93 in the y-axis direction are corresponded to the end portions of an opening in the U-shape. The opening of U-shaped reflection sheet 93 is disposed in the +x-axis direction. That is, when viewed from the +z-axis direction, the U-shape of reflection sheet 93 has its opening in the +x-axis direction. When viewed from the +z-axis direction, the U-shape of reflection sheet 93 has its bending portion in the −x-axis direction. Thus, the effect similar to that of the above-described slanted reflection sheet 93 can be obtained also for the laser light 71 projected in the y-axis direction of light guide rod 4. In addition, the U-shaped reflection sheet 93 may be slanted as described above. Note that, while a configuration of slanting the reflection sheets 93 is shown in FIG. 19, a configuration of not slanting them can be employed, as explained in FIG. 18.

As described above, for example, a linear light source such as a cold-cathode tube emits liner-shaped light having a uniform intensity distribution at the time of emission. However, a laser is a point light source having a spread angle. Therefore, it is converted into liner-shaped light by using the light guide rod 4, as shown in Embodiment 1 or 2. Although such a configuration is employed, the light projected from light guide rod 4 does not travel in a uniform direction, unlike the light projected from cold-cathode tube.

Thus, the prism sheet 91 or diffusion sheet 92 is disposed at the inside of reflection unit 6, not at the position of diffusion plate 3. By employing such a disposition, the light whose traveling direction has been changed by the prism sheet 91 or diffusion sheet 92 can be broadened at the inside of reflection unit 6 with reduced deviation. And thus, uniformity of light entering the diffusion plate 3 can be improved.

The reflection sheet 93 also has a role of broadening the light whose traveling direction has been changed by the reflection sheet 93, at the inside of reflection unit 6 with reduced deviation. Thus, it is highly effective if the reflection sheet 93 is disposed only at the periphery of light guide rod 4. That is, between the reflection sheets 93 of neighboring light guide rods 4, the opening 95 (gap or opening) is formed so that the light can travel in the axis direction of light guide rod 4 (x-axis direction). Thus, the light whose traveling direction has been changed by the reflection sheet 93 can be broadened at the inside of reflection unit 6 with reduced deviation.

As shown in FIG. 19, the reflection sheets 93 may be disposed so as to be slanted with respect to the axis direction of light guide rod 4. Thus, the light whose traveling direction has been changed by the reflection sheet 93 can be broadened at the inside of reflection unit 6 with reduced deviation.

The laser light is broadened by its own spread angle. That is, the laser light is more broadened as it propagates longer distance. Thus, different slant angles may be employed between a reflection sheet 93 at the neighborhood of light incident surface 41 and a reflection sheet 93 located away from the light incident surface 41. The reflection sheet 93 at the neighborhood of light incident surface 41 may have a large slant angle and the reflection sheet 93 located away from the light incident surface 41 may have a small slant angle. The slant angle may be changed continuously. The slant angle may be changed in a stepwise fashion. “Slant angle” means an angle of tilting from a plane perpendicular to the x-y plane. That is, it means an angle with respect to a plane perpendicular to the axis of light guide rod 4.

The above-described reflection sheet 93 having the U-shape may also employ the changing of its slant angle. In a case of such a curved surface, different widening levels may be employed between the reflection sheet 93 at the neighborhood of light incident surface 41 and the reflection sheet 93 located away from the light incident surface 41. The reflection sheet 93 at the neighborhood of light incident surface 41 may have a small widening level and the reflection sheet 93 located away from the light incident surface 41 may have a large widening level.

Here, “widening level” means, for example, a dimension of the radius of curvature in an arc shape. A small radius of curvature has a small widening level and a large radius of curvature has a large widening level.

For example, in a case of parabola passing the origin (Y=aX²), if Y value is supposed to be the same, a small X value has a small “widening level” and a large X value has a large “widening level”.

That is, it is assumed that there is a plane, perpendicular to the axis, located at a position being away, by a predetermined distance on the axis of light guide rod 4, from a position where the axis of light guide rod 4 intersects with the curved surface of reflection sheet 93. “Widening level” is small if a position where the plane intersects with the curved surface is close to the axis, and “widening level” is large if the position is away from the axis.

Thus, the light whose traveling direction has been changed by the reflection sheet 93 can be broadened at the inside of reflection unit 6 with reduced deviation.

That is, an angle between the light guide rod 4 and the traveling direction of light projected from the light guide rod 4 is small at the neighborhood of light incident surface 41. Thus, in order to reflect the light in the direction perpendicular to the axis of light guide rod 4, the slant angle of reflection sheet 93 is set to be large and the widening level of reflection sheet 93 is set to be small.

The angle between the light guide rod 4 and the traveling direction of light projected from the light guide rod 4 is large at a position away from the light incident surface 41. Thus, in order to reflect the light in the direction perpendicular to the axis of light guide rod 4, the slant angle of reflection sheet 93 is set to be small and the widening level of reflection sheet 93 is set to be large.

The reflection surface of reflection sheet 93 shown in FIG. 19 is slanted toward the opening 66 side. The reason is that the laser light 71 projected from the light guide rod 4 is reflected by the reflection sheet 93 so that the traveling direction of laser light 71 is directed toward the opening 66 side. However, the reflection surface may be slanted toward the base plate 61 side. The reason is that, even if the laser light 71 projected from the light guide rod 4 travels toward the base plate 61 side, it is projected through the opening 66 after reflected by the base plate 61. In addition, both surfaces of the reflection sheet 93 may be employed as reflection surfaces. By employing the both surfaces as reflection surfaces, diffusion of light in the reflection unit 6 is promoted and thus uniform and sheet-like light can be obtained easily.

The planar light source device 200 or 201 may further include optical path changing portions 91, 92, 93 for changing the traveling direction of laser light 71. The optical path changing portions 91, 92, 93 are disposed at the inside of reflection unit 6.

The optical path changing portion includes optical path changing members 91, 92 having optical path changing surfaces. The optical path changing surface is disposed at the opening 66 side relative to the light guide rod 4. The traveling direction of laser light 71 is changed by the optical path changing surface when the laser light 71 transmits therethrough. Here, the optical path changing surface is a prism surface or diffusion surface, for example.

The optical path changing portion includes the reflection sheet 93 having a reflection surface. The reflection surface has a cutout or hole provided thereon, and is disposed so as to intersect with the light guide rod 4 by inserting the light guide rod 4 through the cutout or hole.

An opening is provided between the reflection surfaces of reflection sheets 93 of neighboring light guide rods 4.

The reflection surface is slanted with respect to the axis of light guide rod 4.

If a slant angle is defined as an angle with respect to a plane perpendicular to the axis of light guide rod 4 and if the reflection surface is a flat surface, the slant angle of reflection surface changes from large value to small value as moving from a position of laser light source 7 toward the traveling direction of laser light 71.

If the reflection surface is a curved surface, the widening level with respect to the axis of light guide rod 4 changes from small value to large value as moving from a position of laser light source 7 toward the traveling direction of laser light 71.

In the explanation of above embodiments, the light incident surface 41 is assumed to be a plane parallel to the y-z plane. However, for example, a configuration may be employed in which the surface 41 is a plane parallel to the x-y plane and the incident laser light 71 is turned back by a reflection surface or the like. The same will apply to a case where the surface 42 is employed as a light incident surface. In this case, it is easy to dispose a circuit board for driving the laser light source 7 at the rear surface side (−z-axis side) of reflection unit 6, and thus a narrowed bezel can be easily obtained.

Note that, while embodiments of the present invention are explained as above, the present invention should not be limited to these embodiments.

### REFERENCE NUMERALS

200, 201 planar light source devices; 100, 101 liquid crystal display devices; 1 liquid crystal display element; 1a display screen; 1b rear surface; 2 optical sheet; 3 diffusion plate; 4 light guide rod; 41 light incident surface; 42 surface; 5 reflection end portion; 6 reflection unit; 61 base plate; 62, 63, 64, 65 side plates; 66 opening; 7 laser light source; 17R, 17G, 17B laser emitting elements; 71 laser light; 8 LED light source; 81 LED; 82 lens; 83 LED light; 10 diffusion material; 11 prism-shaped portion; 32 liquid crystal display element driver; 33a LED light source driver; 33b laser light source driver; 34 image signal; 35 liquid crystal display element control signal; 36a LED light source control signal; 36b laser light source control signal; 91 prism sheet; 92 diffusion sheet; 93 reflection sheet; 94 cutout portion; and 95 opening.

1-11. (canceled)

12. A planar light source device comprising:
a first light source that emits first light;
a light guide rod that forms a rod shape, that has a light incident surface at an end portion of the rod shape in its longitudinal direction, and that converts the first light entering through the light incident surface into liner-shaped light;
a second light source that emits second light having a spread angle larger than that of the first light; and
a reflection unit that forms a box-like shape including a base plate, side plates being connected to the base plate, and an opening facing the base plate, inner surfaces of the base plate and the side plates being reflection surfaces, wherein
the light guide rod is disposed at a portion enclosed by the reflection surfaces;
light projected from the light guide rod is reflected by the reflection surfaces and is projected through the opening; and
the second light that is projected from the second light source and that spreads from a side of the base plate toward an inside of the reflection unit is reflected in the reflection unit and is projected through the opening.

13. The planar light source device in claim 12, further comprising
an optical path changing portion that changes a traveling direction of the first light projected from the light guide rod, wherein
the optical path changing portion is disposed at an inside of the box-like shape of the reflection unit.

14. The planar light source device in claim 13, wherein
the optical path changing portion includes a first optical path changing member having a first optical path changing surface; and
the first optical path changing surface is disposed at a side of the opening relative to the light guide rod and, when the first light projected from the light guide rod transmits therethrough, changes an optical path of the first light.

15. The planar light source device in claim 13, wherein
the optical path changing portion includes a second optical path changing member having a second optical path changing surface; and
the second optical path changing surface has a cutout or a hole provided on the second optical path changing surface and, by inserting the light guide rod through the cutout or the hole, is disposed so as to intersect with an axis of the light guide rod.

16. The planar light source device in claim 15, wherein the second optical path changing surfaces of the light guide rods being adjacent with each other are disposed so that an opening is provided between the light guide rods being adjacent with each other.

17. The planar light source device in claim 15, wherein the second optical path changing surface is slanted with respect to the axis of the light guide rod.

18. The planar light source device in claim 17,
under the assumption that a slant angle is an angle with respect to a plane perpendicular to the axis of the light guide rod,
wherein, when the second optical path changing surface is a flat surface and a plurality of the second optical path changing surfaces is provided, the slant angle of the plurality of the second optical path changing surfaces becomes small as a location thereof moves away from a location of the first light source.

19. The planar light source device in claim 17, wherein, when the second optical path changing surface is a curved surface and a plurality of the second optical path changing surfaces is provided, a widening level of the plurality of the second optical path changing surfaces with respect to the axis of the light guide rod becomes large as a location thereof moves away from a location of the first light source.

20. A liquid crystal display device comprising:
the planar light source device in claim 12; and
a liquid crystal display element that receives light emitted by the planar light source device and that projects image light.

21. The liquid crystal display device in claim 20, wherein the first light source is disposed at a lower end of the reflection unit.

22. A planar light source device comprising:
a first light source that emits first light;
a light guide rod that forms a rod shape, that has a light incident surface at an end portion of the rod shape in its longitudinal direction, and that converts the first light entering through the light incident surface into liner-shaped light;
a reflection unit that forms a box-like shape including a base plate, side plates being connected to the base plate, and an opening facing the base plate, inner surfaces of the base plate and the side plates being reflection surfaces; and
an optical path changing portion that is disposed at an inside of the box-like shape of the reflection unit and that changes a traveling direction of the first light projected from the light guide rod, wherein
the light guide rod is disposed at a portion enclosed by the reflection surfaces;
the optical path changing portion includes a second optical path changing member having a second optical path changing surface;
the second optical path changing surface has a cutout or a hole provided on the second optical path changing surface and, by inserting the light guide rod through the cutout or the hole, is disposed so as to intersect with an axis of the light guide rod; and
a traveling direction of light projected from the light guide rod is changed by the reflection surfaces or by the second optical path changing surface and the light is projected through the opening.

23. The planar light source device in claim 22, wherein the second optical path changing surfaces of the light guide rods being adjacent with each other are disposed so that an opening is provided between the light guide rods being adjacent with each other.

24. The planar light source device in claim 22, wherein the second optical path changing surface is slanted with respect to the axis of the light guide rod.

25. The planar light source device in claim 24,
under the assumption that a slant angle is an angle with respect to a plane perpendicular to the axis of the light guide rod,
wherein, when the second optical path changing surface is a flat surface and a plurality of the second optical path changing surfaces is provided, the slant angle of the plurality of the second optical path changing surfaces becomes small as a location thereof moves away from a location of the first light source.

26. The planar light source device in claim 24, wherein, when the second optical path changing surface is a curved surface and a plurality of the second optical path changing surfaces is provided, a widening level of the plurality of the second optical path changing surfaces with respect to the axis of the light guide rod becomes large as a location thereof moves away from a location of the first light source.

27. A liquid crystal display device comprising:
the planar light source device in claim 22; and
a liquid crystal display element that receives light emitted by the planar light source device and that projects image light.

28. The liquid crystal display device in claim 27, wherein the first light source is disposed at a lower end of the reflection unit.
